(19) United States
(12) Patent Application Publication
(10) Pub. No.: US 2005/0247270 A1
(43) Pub. Date: Nov. 10, 2005

(54) Modular revolving cylinder engine with tangential sparks

(76) Inventor: Francois Tagliafero, St-Mandrier-sur-Mer (FR)

Correspondence Address: Ralph A. Dowell of DOWELL & DOWELL P.C., 2111 Eisenhower Ave., Suite 406, Alexandria, VA, 22314, US

(21) Appl. No.: 10/515,904

(22) PCT Filed: May 28, 2003
(86) PCT No.: PCT/FR03/01607

§ 371 Date: Jun. 16, 2005

(30) Foreign Application Priority Data
May 29, 2002 (FR) 02/06531
May 28, 2003 (FR) 03/06455

(51) Int. Cl. F02B 53/04

(52) U.S. Cl. 123/43 C

(57) ABSTRACT

The invention concerns a modular revolving cylinder engine consisting of two interdependent flywheels driven in rotation by a slide-free driving device (1) rotating them in synchronization and in opposite directions. Said flywheels comprise on their periphery and offset on a parallel to the diameter units consisting of pushrod supports (5) with chambers (4), sliding hollow pushrods (7 or 7B), compression spring (6). When the two pushrods (7) and (7B) are interlocked, the pre-compressed detonating flux latent in the hollow induction shaft fills the chambers and the pushrods through the corresponding slots (2) and (3). When said slots are no longer corresponding a spark triggers the explosion. The explosion gas deflagrating forcefully through the ducts of the pushrods cause the interlocked pushrods to be spaced apart by a separating thrust, thereby driving the flywheels in rotation. This process repeated on the next interlocked pushrods generates the rotating drive force. Said module is designed for all motoring needs, required by spark-ignition engines.

The present invention concerns the design of a modular revolving cylinder engine with tangential sparks, functioning without piston, or connecting rod, or crankshaft, or camshaft, or valve.

Spark-ignition engines in use at the present time are still generally spark-ignition engines with reciprocating pistons, of which the mechanical principle saw the light of day more than a century ago.

However, it is known that this system presents the major drawback of delivering in four-stroke engines only an efficient drive phase of 12.5% and, in two-stroke engines, of 23.6%.

Hence a highly mediocre efficiency of this reciprocating system which is ageing and which should be replaced by a rotary system which is mechanically more logical, therefore finally and certainly more economical.

Moreover, these engines of obsolete technique are heavy and cumbersome and composed of many moving parts subjected to considerable thermal stresses by the unnecessary and parasitic intense frictions that they undergo.

In order to cause said engines to run more smoothly, the makers have been obliged to multiply the number of cylinders in order to overcome these parasitic and antagonistic idle times of each cycle.

Now, despite all sorts of improvements including, inter alia, ancillary devices for better filling of the cylinders, these even very sophisticated engines are very far from functioning flexibly and harmoniously.

It has therefore been sought whether a rotary system exploiting the power of the explosions tangentially might not be capable of replacing this obsolete reciprocating piston system in certain mechanical applications.

It is precisely the principal purpose of this invention to attempt to overcome all the drawbacks of the reciprocating piston engine which furnishes per cylinder in a four-stroke cycle only one drive stroke per two revolutions, while one sole module of this engine is capable of furnishing a plurality of drive strokes per revolution, hence a possible, very slow idling.

In order to exploit directly, i.e. in tangential manner, the power of the explosions, the technique imagined in the design of this engine has been to mount, offset on a parallel to the line passing through the centre of each flywheel and at a strictly identical distance, units of elements indispensable for the optimum recovery of this power of explosion, these units being distributed at perfectly equal intervals over the periphery of the flywheels, each unit being positioned so that its own axis is parallel to this line of the centre at a distance therefrom identical for all the units.

These units of elements being, with reference to the accompanying drawings, pushrod supports (5) communicating with their chamber (4) and holes for spark plugs (8), sliding hollow pushrods (7 and 7B) in their pushrod support (5) and their compression spring (6).

According to a first characteristic, this engine is composed of two intake flywheels (Va) perfectly in line in the same plane perpendicular to their respective axis, interdependent in rotation by a slide-free drive system (1) which rotates them in synchronization and at absolutely equal speed in opposite directions from each other.

These flywheels comprise on their periphery and at perfectly equal intervals, the same number of units offset in accordance with the technique explained hereinabove, comprising: pushrod supports (5) with chamber (4) and holes for spark plugs (8), sliding hollow pushrods (7) or (7B), compression springs (6).

These flywheels are fixed by their respective shaft on a rigid and perfectly undeformable common support in order that the distance separating their centre, once adjusted, is perfectly invariable.

They each comprise as many slots (3) as chambers (4) and holes for spark plugs (8), and rotate freely via hubs or bearings on their hollow shaft which comprises the intake slot (2).

The drive system (1) which renders the two flywheels interdependent in rotation by rotating them in opposite directions with respect to each other, is wedged so that, upon each revolution of flywheel, each pushrod (7) of one flywheel always interlocks with the same pushrod (7B) which corresponds thereto of the other flywheel.

Furthermore, it is during this interlocking that the detonating flux penetrating at the same time via each intake shaft (9), simultaneously fills through the slots (2) and (3) each chamber (4) and its corresponding hollow pushrod (7) or (7B). The drive force is collected by a pinion meshed on the drive system (1) or by a coaxial shaft integral with one of the intermediate gears. Each pushrod (7 and 7B) comprises at the end of its duct a funnel-shaped narrowing acting as nozzle, allowing a higher outlet speed of the gases at the instant of the explosion, as well as a greater force of reaction applied on each pushrod. Moreover, the internal pressure being greater by the narrowing, the two interlocked pushrods undergo a greater thrust one towards 30 the other, promoting seal.

When the intake slot (2) and the slot of the chamber (3) are no longer corresponding, but before the two interlocked pushrods (7 and 7B) disconnect, a spark projects at each spark plug, causing the detonating flux with which the chambers (4) and the hollow pushrods (7 and 7B) are filled, to explode.

The violent increase in pressure of the gases generated by this explosion deflagrating forcefully through the ducts of the opposite pushrods, causes them to be spaced apart.

The pushrods being fast with the flywheels whose axes are immovable, these flywheels are therefore mechanically the destinations of this tangential force which causes them to rotate simultaneously in opposite directions.

The same process being repeated and being successively applied to the following interlocked pushrods, generates the rotary drive force.

The accompanying drawings illustrate the invention.

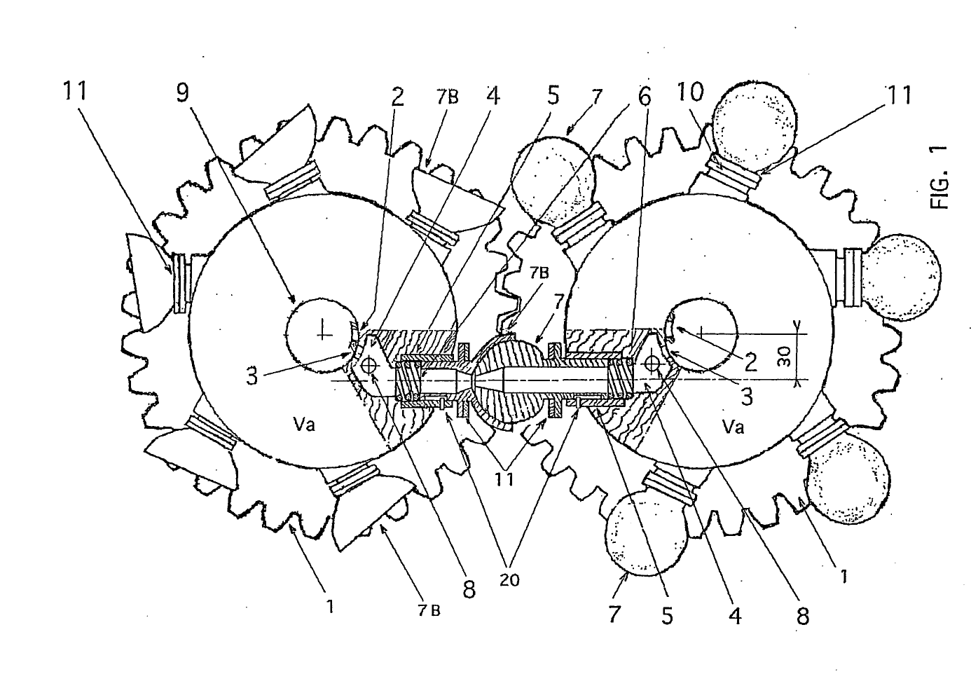

FIG. 1 shows an overall view and a partial section of the elements constituting the engine.

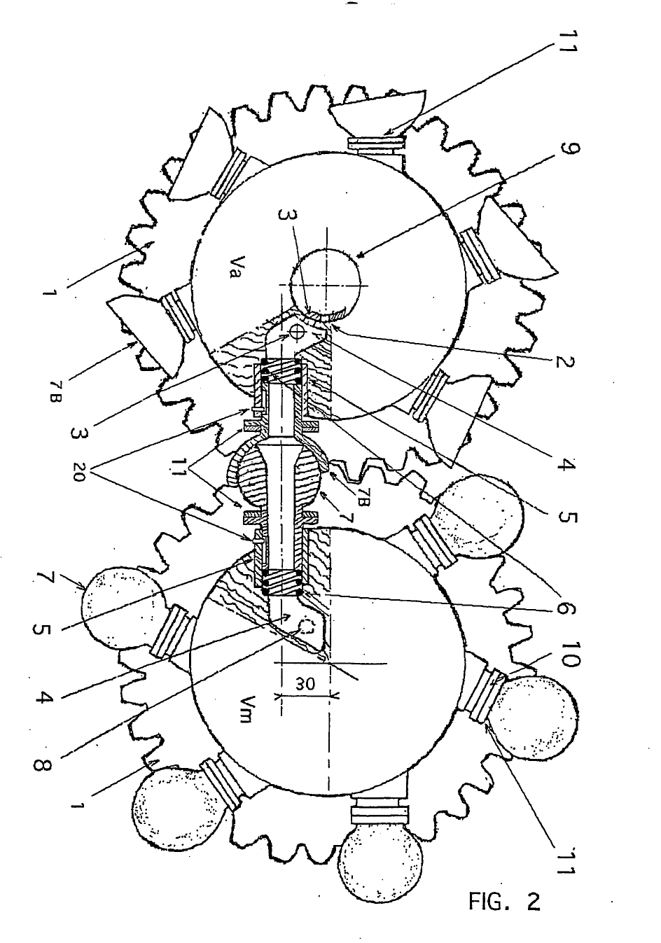

FIG. 2 shows an overall view and a partial section of the elements constituting a variant of this engine.

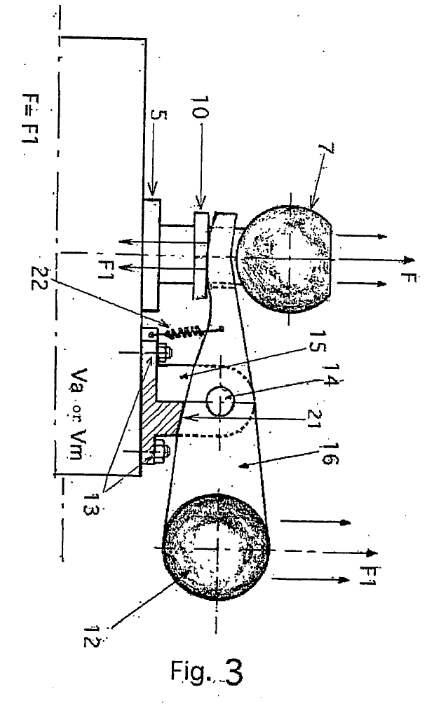

FIG. 3 shows a view of the rockers and their principle of functioning.

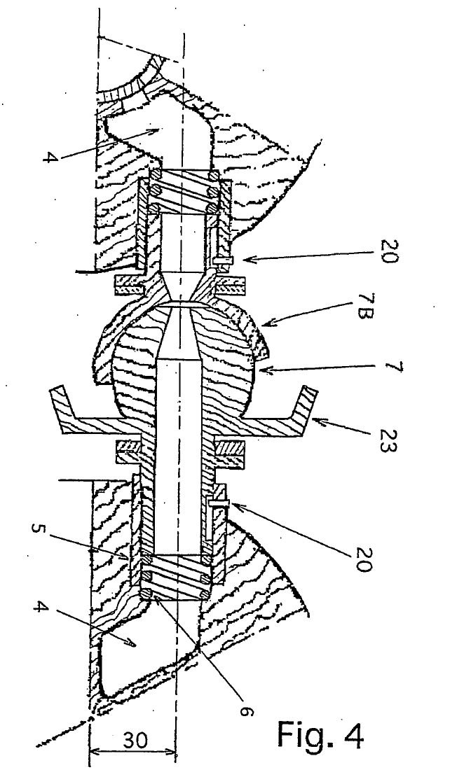

FIG. 4 shows in a particular embodiment of this engine an enlarged view of the catches on the pushrod supports and the location of the shield (23) on a ball-headed pushrod (7).

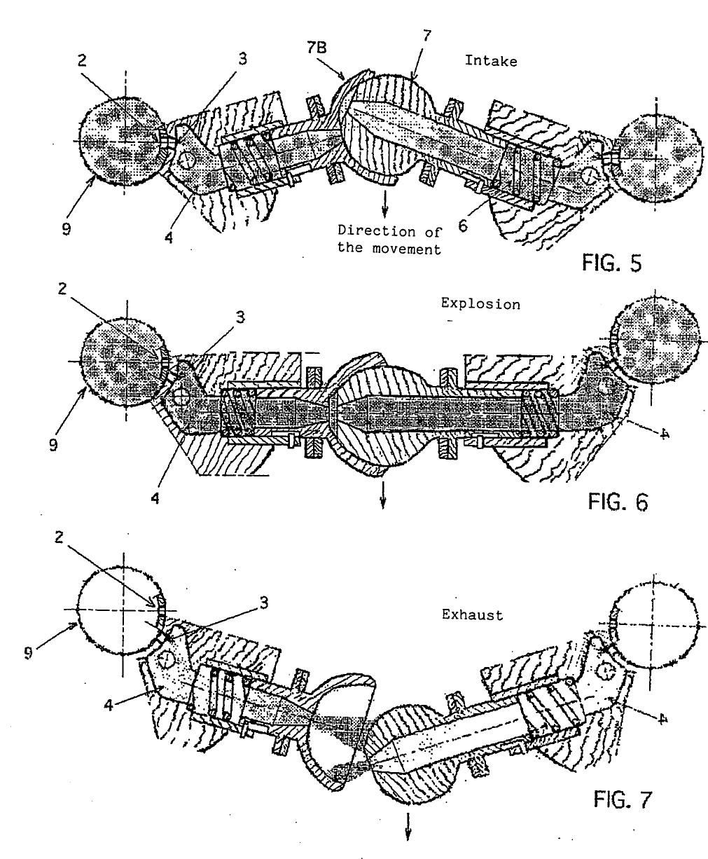

FIGS. 5-6 and 7 show the three consecutive strokes which form a drive cycle by each interlocking.

In the form of embodiment according to FIG. 1, the engine module comprises two intake flywheels (Va), a two-gear drive system (1) which renders these flywheels fast in rotation by causing them to rotate in opposite directions with respect to each other, twelve pushrod supports (5) and their catch (20), six sliding hollow pushrods (7) or (7B) with flange (10) and compression spring (6), twelve stirrup elements (15) and heel (21) rocker (16) with counterweight (12) shaft (14) spring (22).

Each intake flywheel (VA) rotates freely via hubs or bearings on its hollow shaft (9) which comprises the intake slot (2). This flywheel comprises six chambers (4) and their slot (3) six holes for spark plug (8) six pushrod supports (5) and catch (20) six hollow pushrods (7B or 7B) and compression spring (6) six stirrup elements (15) with heel (21) rocker (16) with counterweight (12) shaft (14) spring (22).

In the form of embodiment according to FIG. 2, this engine comprises an intake flywheel (Va), and a motive flywheel (Vm) pushrod supports (5) communicating with their chamber (4), pushrods (7) or (7B) and compression springs (6).

The motive flywheel (Vm) is fast with its shaft which rotates on bearings.

According to particular, non-limiting forms of embodiment:

The two flywheels (Va and Vm) may have variable profiles, shapes and dimensions, bearing equally well pushrods (7) or (7B) of which the end may be of variable, but identical, shape on each flywheel.

The stroke of the pushrods (7 and 7B) may be limited either by a catch (20) fixed on the pushrod support (5) sliding in a housing of adequate length of the pushrod (7 or 7B) or by a heel (21) existing on the stirrup element (15) limiting the oscillation of the rocker and, on the same occasion, the stroke of the pushrod or by a flange formed by a nut and a counter-nut abutting on the edges of the hole of smaller diameter of the pushrod support (5).

The rotation of the pushrods may be prevented either by the catch (20), or by the fork (11) of the rocker surrounding on either side of the flat portions provided on each pushrod or that the section of the pushrods be partly square, hexagonal, etc. sliding in a hole of the pushrod support of corresponding section.

The centrifugal force to which the pushrods are subjected by the rotation of the flywheels may be limited by a flange (10) on which a slightly concave tail of the rocker (11) may abut as a fork, this rocker oscillating on the shaft (14) of its stirrup element (15) comprising a heel (21) which is fixed in correspondence of each pushrod. The other end of the rocker comprising a counterweight (12) whose mass is in relation with the mass of the pushrod (7 or 7B) or of the force to be compensated.

The body of the pushrods and the intake shaft (9) on their cylindrical part and this latter over the periphery of its slot (2) may comprise sealing elements.

The system of drive of the flywheels (1) may be two gears or gear trains (which in this case would facilitate the adjustment of interlocking of the pushrods independently of the primary diameter of these gears) being able to be of thickness and of magnitude different in two's and also of different toothings (spur, helical, double-helical, etc.).

Each gear of the drive system (1) may be integral with its flywheel or added and maintained on the flywheel by an appropriate system of fixation and allowing circularly any positioning or possible adjustment.

The shaft of the motive flywheel (Vm) may be machined with the flywheel or the two portions of shaft mounted and fixed on the flywheel by any means of fixation.

The pushrod supports (5) may be mounted by force on the flywheels in accordance with refrigeration technology or screwed or welded, etc.

The spark at the spark plugs may be provoked by different mechanical or electronic, or partly mechanical and electronic ignitions, on-board or not on the flywheels.

The stirrup elements (15) may be fixed on the flywheels by welding, by bolts, by pins and nuts, etc.

The rockers (16) may comprise a device ensuring permanent contact of the fork (11) on the flange (10), for example a coaxial spiral or tension spring at the front (22) or compression at the rear.

There may be provided on the pushrods (7) to the rear of the end, a shield (23) designed with the pushrod or added, making it possible to exploit as best possible the power of the explosions and to limit their consequences.

There may be provided a system for blocking the pushrods preventing at the instant of the explosion that they be rejected in the pushrod supports.

By way of non-limiting example:

the flywheels having a diameter of 200 mm and the centre of one being distant by 290 mm from the other, the common axis of the pushrod supports-pushrods-compression spring unit of elements is offset on each flywheel by 30 mm on a parallel to the line of the centre, or in drawings 1 and 2, by the parallel to the imaginary line joining the centre of the flywheels.

The end part of the hole of the ball-headed (7) and half-shell (7B) pushrods has a dimension of 6 mm for an internal hole of 12 mm.

This engine should be enclosed in a housing in order to avoid sound nuisances due to the explosions, with an exhaust outlet placed a little higher than the bottom, in order to allow recovery of the lubricant which must not be expelled by the exhaust.

Cooling of the housing may be effected by air with the aid of fins with which it may be provided during casting in the foundry or added or by circulation of water or of oil in its thickness or its double wall or any other adequate means.

In this engine, the greatest frictions being those generated by the interlocking of the pushrods (7) and (7B) and their short linear stroke, lubrication thereof may be effected, by way of example, by a mist of lubricant under pressure directed towards the pushrods and the pushrod supports.

This lubricant would easily be recovered in the bottom of the housing and reinjected into the system after having previously and possibly if necessary passed through a cooling radiator.

The ignition beams should be protected so that they are not exposed to the effect of the explosions.

That part of the pushrods (7 and 7B) ensuring interlocking contact, should be manufactured from very resistant materials (treated steel, titanium, etc.) or partly coated with ceramics and anti-friction materials and comprising either grooves or one or more sealing rings.

The rockers and their counterweights may be manufactured from steel or steel-plated cast iron, the shafts from treated steel.

The flywheels may be manufactured from light materials (treated or steel-plated aluminum or composites) in order to obtain more nervosity, of from heavier material (steel or cast iron) to obtain more power.

Depending on its design, each engine forming a module functions with any, but an equal, number per flywheel, of pushrod supports with chamber, pushrods, rockers, etc., generally from 3 to 6 per flywheel.

There may be formed engines of a plurality of combined engine modules of one of the two versions, either each of these engine modules offset angularly with respect to the preceding one in order to obtain rotary engines like turbines, or non-offset angularly in order to obtain a multiplied resultant of force of explosions or to make a mixture of offset and non-offset modules.

All combinations being possible as desired, in order to satisfy all requirements.

This engine is compatible for functioning with liquid and gaseous fuels.

The drive cycle is composed of three strokes:
1—Intake
2—Explosion
3—Exhaust

1. Engine characterized in that it exploits, in order to obtain its rotary drive power, the separating and repulsive force of couples of interlocking mechanical parts, by explosion of the detonating gaseous mixture that one or both contain, each mechanical part having its shaft common with that of its unit, each unit being mounted on each of the flywheels of an identical pair or on each of the flywheels of a different but complementary pair, these flywheels being perfectly in line and interdependent in rotation by a slide-free drive system which rotates them in synchronization and at absolutely equal speed in the same plane perpendicular to their axis, each unit having its axis offset parallel to the line passing through the centre of its flywheel at a strictly identical distance for all the units, each unit adjusted on each flywheel so that, during rotation, its mechanical part always interlocks perfectly with the same mechanical part of the unit which corresponds thereto on the other flywheel.

2. Engine according to claim 1, characterized in that said mechanical parts are pushrods (7) and (7B), the identical flywheels are two intake flywheels (Va) the two different flywheels are, one, intake (Va), the other motive (Vm), each unit being composed of:
pushrods (7) or (7B)
pushrod supports (5) chamber (4) and slot (3)
compression springs (6)
each flywheel comprising any, but an equal, number of units with pushrods (7) for one and pushrods (7B) for the other, with three systems acting on each pushrod, one limiting its linear stroke, one preventing its rotation, one limiting the centrifugal force to which it is subjected.

3. Engine according to claim 2, characterized in that the stroke of the pushrods is limited either by a catch (20) fixed on the pushrod support and penetrating in the housing of adequate length of the pushrod, or by a heel (21) existing on the stirrup element (15) limiting the oscillation of the rocker and, on the same occasion, the stroke of the pushrod, or by a flange on the front part of the pushrod, stopped by a cap also comprising a smaller hole, fixed on the pushrod support.

4. Engine according to claim 3, characterized in that the rotation of the pushrods is prevented by the catch (20) or by the fork of the rocker (16) surrounding on either side of the flat portions provided on each pushrod body or by the fact that the pushrod bodies have a tongue in a housing, or that their section is partly square, hexagonal, etc. with slide in a hole of the pushrod support of corresponding section.

5. Engine according to claim 4, characterized in that the system limiting the centrifugal force of each pushrod is a rocker (16) with counterweight (12) with return by spring (22), oscillating via a shaft (14) on a stirrup element (15) with heel (21).

6. Engine according to claim 2, characterized in that the pushrods (7) and (7B) and the intake shafts (9) on their cylindrical part and the intake shaft (9) on the periphery of its slot (2) comprise sealing elements.

7. Engine according to claim 2, characterized in that the ducts of the pushrods at the ends comprise a funnel-shaped narrowing acting as nozzle.

8. Engine according to claim 1, characterized in that the drive of the flywheels (1) takes place by gears or gear trains, of variable thickness and magnitude in two's and also of toothings variable in two's (spur, helical, double-helical, etc.).

9. Engine according to claim 1, characterized in that this engine comprises either a single module or banks of a plurality of modules angularly offset with respect to the preceding one in order to obtain units rotating like turbines, or non-offset in order to obtain a multiplied resultant of force of explosions, or to make a mixture of offset and non-offset modules.
